(19) United States
(12) Patent Application Publication
(10) Pub. No.: US 2004/0177107 A1
(43) Pub. Date: Sep. 9, 2004

(54) Method for providing services with guaranteed quality of service in IP access network

(76) Inventors: Wu Qing, Shenzhen (CN); Jiandong Ge, Shenzhen (CN); Guoping Li, Shenzhen (CN); Jianzhong Huang, Shenzhen (CN); Qiwu Liu, Shenzhen (CN)

Correspondence Address: HARNESS, DICKEY & PIERCE, P.L.C., P.O. BOX 828, BLOOMFIELD HILLS, MI, 48303, US

(21) Appl. No.: 10/774,232

(22) Filed: Feb. 6, 2004

(30) Foreign Application Priority Data
Feb. 26, 2003 (CN) 03106929.0

(51) Int. Cl. G06F 15/16

(52) U.S. Cl. 709/200

(57) ABSTRACT

The invention discloses a method for providing services with guaranteed Quality of Service (QoS) in an IP access network. In this method, when the network control layer applies for network resources to the access network as response to the service request of needing guaranteed QoS, the edge router determines whether the access network can provide enough resources for the service. If there are enough resources, the edge router sends QoS parameters to the access network end devices which make QoS control to get a guaranteed QoS.

### CROSS-REFERENCE TO RELATED APPLICATIONS

This application claims the benefit of Chinese Patent Application No. 03106929.0 filed Feb. 26, 2003. The disclosure of the above application is incorporated herein by reference.

### FIELD OF THE INVENTION

The present invention relates to network access technology, more particularly to a method for providing services with guaranteed Quality of Service (QoS) in an Internet Protocol (IP) access network.

### BACKGROUND OF THE INVENTION

At present, IP network of telecommunication service provider can only provide data services as possible. Along with the number of broadband network subscribers increases, the service requirements on IP network are getting more, such as Voice over IP (VoIP) and videoconference etc. These real-time services have strict requirements for QoS.

As shown in FIG. 1, a whole IP network consists of access/edge layers and a backbone layer. The access/edge layer involving the network devices that are closest to the subscribers generally consists of low end switches, such as Layer 2 and Layer 3 switches, a Digital Subscriber Line Access Multiplexer (DSLAM) and an edge router. Subscribers of a broadband IP network of a telecommunication service provider or a company can access to the broadband access network through various ways such as XDSL/Ethernet etc. The broadband access network collects all traffic streams to the edge router connected to the backbone network. The edge router is responsible to route and forward traffic streams in this access network and manage accessed subscriber.

In IP network, in order to provide an end-to-end QoS for service requirements of subscribers, such as VoIP or video-telephone etc., it is necessary to provide end-to-end guaranteed QoS not only in IP backbone network, but also in access network.

Due to design ideas, in general there is no means for guaranteed QoS in prior IP network. In order to adapt the development of network applications, various methods for guaranteeing QoS have been proposed, including integrated service model and differentiated service model. But these methods relate to network layer technology and cannot be used for access network because the devices in access network are mainly located in link layer.

At present, there are two methods for providing an end-to-end guaranteed QoS for IP access network.

In the first prior method, a concept about priority of Ethernet frame is defined in IEEE Standard 802.1p protocol for Ethernet environment. In general, there is no priority definition for ordinary Ethernet frames, but in the 802.1p as well as the 802.1q, four bytes are added in an Ethernet frame. Three bits among the four bytes are used to represent priority of the Ethernet frame. During sending the data packets which are required very high real-time ability, the host or switch will set the three added bits in MAC frame header to show the frame has high priority. In this way, when there is heavy data traffic at Ethernet switch, data packets with high priority will be forwarded first. FIG. 2 shows a general Ethernet frame format, and FIG. 3 shows an Ethernet frame format defined by 802.1q and 802.1p protocols. As shown in FIG. 2 and FIG. 3, the TCI, P, C and VLAN fields are newly added in general Ethernet frame. Among these fields, the P field uses three bits to represent priority which can be set at 8 levels with 0-7.

In prior 802.1p protocol used for access network, the priority represented with three bits of P field is set based on port, Media Access Control (MAC) address or Virtual Bridged LANs (VLAN) information. The access network devices then make dispatching and forwarding operations according to the priority information.

Although the priority information can be set based on port, MAC address or VLAN information in the QoS process in prior 802.1 p, the priority can only be associated with a subscriber and cannot with a specific service of a subscriber. Therefore, the requirement that different services should have different priorities cannot be satisfied. Besides, the network topology and resources cannot be obtained in this method, so it is impossible to determine whether a guaranteed QoS can be provided for a subscriber service based on the network resources.

At present, there is no QoS control mode for ATM DSLAM. In the second prior method, for a few ATM DSLAMs provided guaranteed QoS, a Permanent Virtual Circuit (PVC) from the Remote Terminal Unit (RTU) to the Broadband Access Server (BAS) for a special subscriber is established, or a PVC from the DSLAM to the BAS but tied with the user port is established. In this way, traffic streams can be transmitted with Constant Bit Rate (CBR) mode. Since a single subscriber uses the whole broadband, the QoS for subscriber service can be guaranteed at this segment of access network

The mode that a single subscriber uses the whole broadband is similar to the mode of a leased line. Although this mode can ensure QoS at a certain segment of access network for the subscriber, it is not suitable for being spread in access network with convergence characteristic and it can only provide guaranteed QoS for a few special subscribers. The mode of establishing PVC cannot make the network sources be shared. Accordingly, this method can only be used for special applications and cannot be commonly used in access network.

### SUMMARY OF THE INVENTION

An object of the invention is to provide a method for providing services with guaranteed QoS in an access network.

The method according to the invention comprises the following steps:

a. a service entity at the network service control layer obtaining the addresses of the calling subscriber and the called subscriber and QoS requirement for the service through analyzing the service request, then applying for network resources to corresponding access network of the IP access network;

b. the edge router of said access network determining whether enough resources can be provided for this service according to the current resource condition, if so, executing step c, otherwise rejecting the service request of the subscriber; and

c. if there are upward traffic streams of the access network in this service, said edge router informing an access network end device of the QoS requirement for the service, the access network end device processing said traffic streams according to the QoS requirement;

If there are downward traffic streams of the access network in this service, said edge router setting priority in access network for this service and forwarding said traffic streams.

In this invention, the edge router can manage resources of an access network, and inform the access network end devices of the QoS requirement of the service, and then let the end devices make stream classification operations and QoS processes. When there are no enough resources for the service, the service request will be refused. In this way, the QoS of the working traffic streams can be guaranteed. The combination of the method according to the invention and the method for providing services with QoS in backbone network can provide end-to-end services with guaranteed QoS all over the network. The invention overcomes the disadvantages that the access network devices cannot identify services and cannot obtain the information about resources and manage resources so that QoS cannot be guaranteed in the prior art.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows the architecture of an IP network.

FIG. 2 is a schematic diagram illustrating the format of a general Ethernet frame.

FIG. 3 is a schematic diagram illustrating the format of an Ethernet frame defined by 802.1q and 802.1p protocols.

FIG. 4 is a flowchart diagram of the invention.

FIG. 5 shows the architecture of the IP network according to an embodiment of the invention.

### DETAILED DESCRIPTION OF THE PREFERRED EMBODIMENTS

The following description of the preferred embodiment(s) is merely exemplary in nature and is in no way intended to limit the invention, its application, or uses.

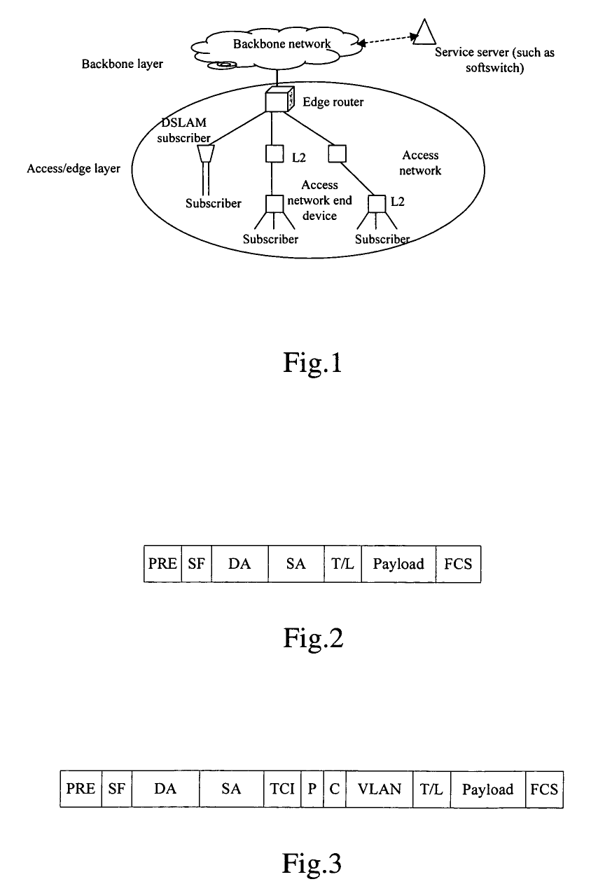

Referring to FIG. 1, the prior networking mode for access network is not changed in the invention. A whole IP network consists of access/edge layers and a backbone layer. The access/edge layer involving the network devices that are closest to the subscribers generally consists of low end switches, such as Layer 2 and Layer 3 switches, a DSLAM and an edge router. Subscribers of an IP network of a telecommunication service provider or a company can access to the IP access network through various ways such as XDSL/Ethernet etc. The IP access network collects all traffic streams to the edge router connected to the backbone network. The edge router is responsible to route and forward traffic streams in this access network and manage accessed subscriber. An IP access network consists of multiple access networks logically, and each subscriber is managed by one of the access networks. The router of each access network is responsible for resource management and QoS control for access network in this access network. After traffic streams leave the access network, the IP backbone network is responsible for providing guaranteed QoS for the traffic streams.

An access network is defined as an access network area managed by an edge router. All subscribers in the access network area can access to the backbone network through the edge router. In term of function, access network devices in an access network can be divided into three types. The first type is edge routers, such as edge routers R1 and R2. As output devices of the access network, the edge routers are used to connect the access network and the backbone network. Meanwhile, they are the first IP hops for a user to access Internet. The second type is end devices of the access network which are the devices closest to the subscribers, such as DSLAM for XDSL access and L2 switch for LAN access. The devices of the third type are the network devices located between the devices of the first type and those of the second type. In practice, there can be the devices of the third type in the network or not. For XDSL, there may be no devices of the third type, and for LAN access, the devices of the third type are usually switches L2 and L3. For example, the access network area 1 is managed and connected to the backbone network through edge router R1, the subscriber 1 of access network 1 can access to the edge router R1 through switch L2-1 etc.

In this invention, the access network end devices should have the ability of accepting and processing QoS commands from the edge router and the ability of classifying traffic streams. Here, the access network end devices refer to the network devices at layer 2 or higher layer in access network which are the most closed to subscribers. Meanwhile, it is necessary for the end devices to identify traffic streams according to QoS parameters, to manage bandwidth and set priority.

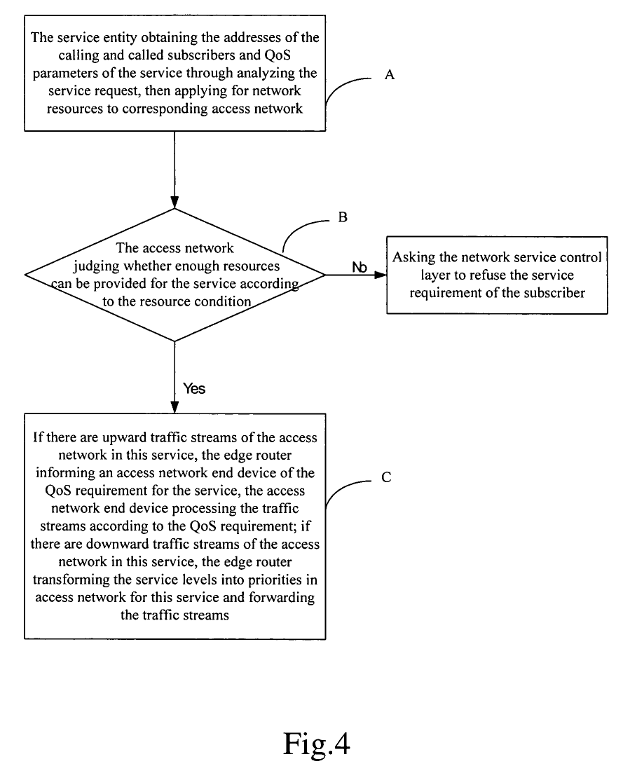

As shown in FIG. 4, the method according to the invention comprises the following steps.

In step A, the service entity at the network service control layer analyzes the service request with QoS requirement to obtain the addresses of the calling subscriber and the called subscriber and QoS parameters about this service, then applies to the corresponding access network of the IP access network for network resources.

If a subscriber in an access network wants to use a service with guaranteed QoS, such as VoIP call and video telephone call etc., the subscriber needs to submit a request to corresponding service entity. When the request has been received, the service entity judges the service rights of the subscriber and makes address analysis of the calling subscriber and the called subscriber. Then the service entity determines QoS parameters for this conversion, such as bandwidth etc., and applies for the necessary network resources to the edge router. The method of applying for network resources to edge router can be direct or indirect, such as through policy server, resource controller etc. The interface protocol used for resource application can be either an internal interface protocol or an open interface protocol depending upon the implementing method of providing guaranteed QoS in the backbone network.

The QoS parameters sent to the edge router from the service entity include, but not be limited to, bandwidth, directions of the traffic streams and parameters for identifying the traffic streams. The directions of service streams can be unidirectional (upward or downward) or bi-directional. According to the application environment, the parameters for identifying the traffic streams can be a five-element group (source/destination IP addresses, source/destination port numbers and protocol number), a four-element group (source/destination IP addresses, destination port number and protocol number) or a seven-element group.

In step B, the edge router of the access network judges whether the access network has the ability of providing enough resources for this service; if so, step C is executed, otherwise the edge router asks the network service control layer to reject the service request of the subscriber.

Having pre-planed resources and topology structure of the access network, the edge router obtains the information about network topology structure and bandwidth resources of each interface through static configuration or dynamic management protocol, and records the tying relationship between the subscriber identifier, such as IP address, allocated inside the access network and the end device of the access network. The bandwidth resource refers to the bandwidth of the Ethernet links for Ethernet and IP DSALM access mode, and refers to the bandwidth from DSLAM to BAS for ATM DSLAM access mode.

After receiving a resource request for the service, the edge router computes the bandwidth between the end devices of the access network and the edge router according to the relevant parameters of the service request. If there are no enough resources in the access network, the edge router will notify corresponding service entity to reject the service request. In contrast, if there are enough resources, the information will be sent back to corresponding service entity. After receiving the confirmation information from this service entity, the edge router will make corresponding processing according to the directions of traffic streams.

In step C, if the service has upward traffic streams in the access network, the edge router will inform the end devices of access network of the QoS parameters of the traffic streams, and the end devices will process the traffic streams based on the QoS parameters. If the service has downward traffic streams in the access network, the edge router will define priorities of the traffic streams in the access network and forward the traffic streams.

In detail, the edge router of the access network will make the following processes for traffic streams based on their directions.

For upward service streams, the edge router sends QoS commands involving QoS parameters to corresponding access network end devices in the access network through management protocol, and asks the access network end devices to process the traffic streams based on the QoS parameters. The QoS commands sent to the access network end devices include bandwidth and parameters for identifying traffic streams. According to the application environment, the parameters for identifying the traffic streams can be a five-element group (source/destination IP addresses, source/destination port numbers and protocol number), a four-element group (source/destination IP addresses, destination port number and protocol number) or a seven-element group. After having received the QoS parameters of traffic streams, the access network end devices set the items of stream classification table based on the parameters for identifying the traffic streams, implement stream classification for the upward traffic streams of subscriber, and then make corresponding processes based on the stream classification result. For the service streams that are matched with the stream classification table, the bandwidth management, such as bandwidth limitation, is processed according to bandwidth parameters. During forwarding the traffic streams for Ethernet access or IP DSLAM access, the packets are set with high priorities first and forwarded then. During forwarding the traffic streams for ATM DSLAM access, the service streams are sent on PVC with guaranteed QoS for further forwarding. In this way, since bandwidth of the PVC with guaranteed QoS is allocated according to the stream classification result, the bandwidth can be shared according to traffic streams of subscribers, which overcomes the disadvantage of the prior method that a single subscriber uses the whole bandwidth for guaranteeing QoS with CBR mode. The traffic streams that are not matched with the stream classification table will be processed as traffic streams without guaranteed QoS. During forwarding the traffic streams without guaranteed QoS for Ethernet access or IP DSLAM access, the packets are set with low priorities first and then forwarded, and for ATM DSLAM access, the traffic streams are sent to PVC with UBR mode for further forwarding.

For downward traffic streams, the edge router doesn't need to send relevant commands to access network end devices. If the priorities of the traffic streams can be determined trough the backbone network or the traffic streams themselves, the received traffic streams are set priorities in access network according to service levels of the traffic streams directly, and then forwarded. Otherwise, the edge router makes stream classification first, and then forwarding the traffic streams based on the priorities in access network after identifying traffic streams.

For the traffic streams with upward and downward directions, the edge router processes the traffic streams according to the processing of upward direction and that of downward direction respectively.

If the originator and the receiver are subscriber of the same access network, the service procedure is implemented separately according to the above-mentioned procedures.

Before receiving QoS commands from the edge router, access end devices deal with traffic streams from subscribers as a service without guaranteed QoS. That is, the access end devices forward the packets after setting low priorities to them first. For ATM DSLAM access, service streams are sent to PVC with UBR mode for further forwarding.

The devices of the third type located between the edge router and access end devices only forward IP packets according to their service levels.

After the subscriber terminates the service, if there are upward traffic streams, the access network end devices will receive QoS release commands from the edge router, and then cancel corresponding items of the stream classification table.

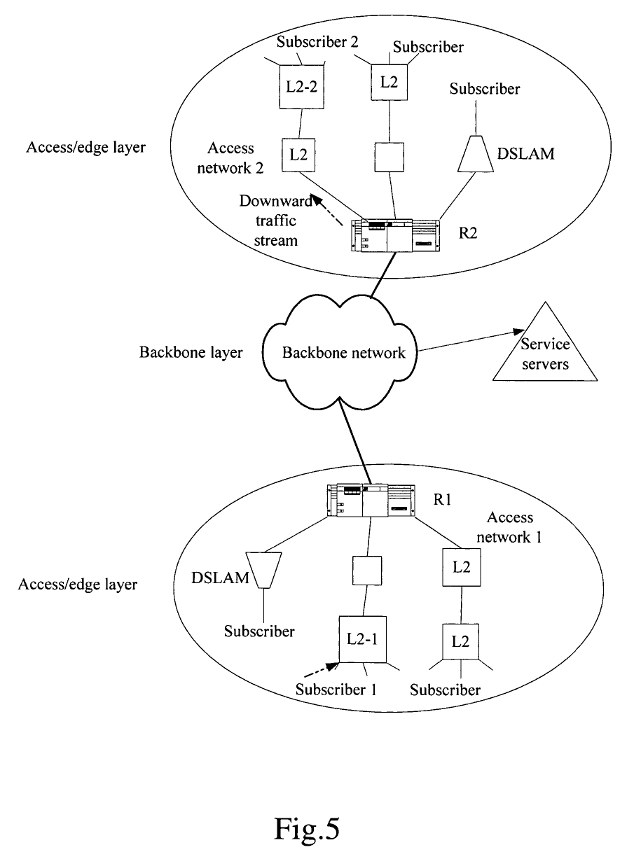

As shown in FIG. 5, the subscriber 1 in access network 1 wants to send traffic streams with guaranteed QoS to the subscriber 2 in access network 2. First, the subscriber 1 sends out a service request, after analyzing the addresses of the subscribers 1 and 2, i.e., the addresses of the calling and called subscribers, and relevant QoS parameters, the service entity at network control layer applies for network resources from the access networks 1 and 2 for the service. The edge routers R1 and R2 determine whether enough resources can be provided for the service according the current resource situation of the access networks 1 and 2 respectively. If both the access networks 1 and 2 can provide enough resources, the edge routers R1 and R2 return the information to the service entities. After receiving confirmation messages from the service entities, the edge router R1 of the access network 1 sends QoS commands involving QoS parameters to the end device L2-1. According to the QoS parameters, the end device L2-1 sets items of stream classification table to making stream classification operations for the upward traffic streams of the subscriber 1, and matches the results of stream classification operations with the items of the stream classification table. The traffic streams matched with the items are managed and forwarded according to the bandwidth parameters. The unmatched traffic streams are processed as traffic streams without guaranteed QoS. At the same time, for the downward traffic streams, if their priorities can be obtained through methods for backbone network or traffic streams themselves, the edge router R2 of the access network 2 transforms the service levels of the traffic streams forwarded from the backbone network to priorities used in the access network without sending relevant commands to access network end devices, and then forwards the traffic streams to the end device L2-2 from which the subscriber 2 can receive the traffic streams. Otherwise, the edge router R2 makes stream classification operations first, and then forwards the traffic streams to the end device L2-2 from which the subscriber 2 can receive the traffic streams after identifying the traffic streams.

If the access network 1 or 2 cannot provide enough resources for the service, the corresponding edge router will notify the service entities to refuse the service request of subscriber 1.

If the traffic streams between subscribers 1 and 2 are bi-directional, it is necessary for the edge routers R1 and R2 not only to send QoS commands to the end devices L2-1 and L2-2 respectively, but also to forward the service streams received from the backbone network.

It can be seen from above that services with guaranteed QoS can be provided on a broadband access network with the method according to the invention. The end-to-end services with guaranteed QoS can be provided through the combination of the scheme for IP backbone network and the method according to the invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for providing services with guaranteed Quality of Service (QoS) in an IP access network, comprising:
a. a service entity at the network service control layer obtaining the addresses of the calling subscriber and the called subscriber and QoS requirement for the service through analyzing the service request, then applying for network resources to corresponding access network;
b. the edge router of said access network judging whether enough resources can be provided for this service according to the current resource condition, if so, executing step c, otherwise rejecting the service request of the subscriber; and
c. if there are upward traffic streams of the access network in this service, said edge router informing an access network end device of the QoS requirement for the service, the access network end device processing said traffic streams according to the QoS requirement;
if there are downward traffic streams of the access network in this service, said edge router setting priority in access network for this service and forwarding said traffic streams.

2. The method according to claim 1, wherein in step c, said edge router can transform the service levels into priorities in the access network for the received service streams and forward said traffic streams; or can classify streams first, after identifying the traffic streams, transform the identified results into priorities in the access network and forward the traffic streams.

3. The method according to claim 1, wherein step c is executed after said edge router has informed the service entity at network service control layer that the access network can provide enough resources for the service and has received confirmation from the service entity.

4. The method according to claim 1, further comprising the step of said edge router obtaining at least topology structure of the access network and bandwidth resources of each interface through static configuration or dynamic management protocol.

5. The method according to claim 1, after the access network end device receives QoS requirement of the service in step c, the method further comprising:
setting items of a stream classification table according to the parameters for identifying traffic streams in the QoS requirement;
classifying the received upward traffic streams of the subscriber; and
managing bandwidth according to bandwidth parameters for the service streams matched with the items of the stream classification table, and processing the other service streams as traffic streams without guaranteed QoS.

6. The method according to claim 5, wherein the step of forwarding the matched service streams by end devices is:
setting the service streams with high priorities and then forwarding the traffic streams for Ethernet access or IP Digital Subscriber Line Access Multiplexer (DSLAM) access; and
sending the traffic streams to Permanent Virtual Circuit (PVC) with guaranteed QoS for further forwarding for ATM DSLAM access.

7. The method according to claim 5, wherein the parameters for identifying traffic streams can be a four-element group, a five-element group or a seven-element group.

8. The method according to claim 1, further comprising: before receiving QoS parameters from the edge router of the access network for upward traffic streams, the end devices processing the received traffic streams from the subscriber as service streams without guaranteed QoS.

9. The method according to claim 1, wherein the network devices between said access network end devices and said edge router of the access network forward the traffic streams according to the priorities of the traffic streams.

10. The method according to claim 5, further comprising: after the subscriber terminates the service, if there are upward traffic streams, said edge router sending a QoS release command, the access network end devices deleting corresponding items of the stream classification table according to the command parameters.

11. The method according to claim 6, further comprising: after the subscriber terminates the service, if there are upward traffic streams, said edge router sending a QoS release command, the access network end devices deleting corresponding items of the stream classification table according to the command parameters.

12. The method according to claim 7, further comprising: after the subscriber terminates the service, if there are upward traffic streams, said edge router sending a QoS release command, the access network end devices deleting corresponding items of the stream classification table according to the command parameters.
